(19) United States
(12) Patent Application Publication
(10) Pub. No.: US 2003/0174011 A1
(43) Pub. Date: Sep. 18, 2003

(54) Method of stabilization of operating conditions in electronic devices

(76) Inventor: Evgueni Sergeyevich Alechine, Khabarovsk (RU)

Correspondence Address: Evgueni Sergeyevich Alechine, Apt. 20, Irtyshskaya St., 17, Khabarovsk, 680006, RU

(21) Appl. No.: 09/731,049

(22) Filed: Dec. 7, 2000

(51) Int. Cl. G05F 1/10

(52) U.S. Cl. 327/538

(57) ABSTRACT

An invention relates to the field of electronic engineering and can be used to stabilize of direct current operating conditions in electronic devices. An object of the invention is stabilization of electronic schematic operating conditions independent of a temperature of crystal body of the amplifying element and an environmental temperature. A method lets to obtain an object of the invention by using of the active non-linear direct current negative feedback.

### BACKGROUND OF THE INVENTION

An invention relates to the field of electronic engineering and can be used to establish and stabilize direct current operating conditions in electronic devices.

It is known various methods to receive bias voltage as have been described in Sound Engineering Reference by Paul Skritek of 1991. A base of the methods is a bias voltage receiving principle with the help of a voltage source concerning an element dependent of a temperature and which is fitted to the direct thermal contact on a case of the amplifying elements. FIG. 13.4.4.g as have been described in Sound Engineering Reference by Paul Skritek of 1991 shows an standard schematic representation of the establishing of bias voltage which have been widely extended. However, it is practically impossible to obtain absolute thermal compensation by such method because of a temperature difference of the output transistor case and a semiconductor crystal temperature and also because of a big time constant in control circuit. An object of the invention is stabilization of operating conditions in electronic schemes independent of a temperature of crystal body of the amplifying element as have been described in Operating Devices by G. S. Ostapenko, p.4, of 1989 and an environmental temperature and also a removal of time delay in control circuit.

### SUMMARY OF THE INVENTION

The object is obtained by leading of the active non-linear direct current negative feedback.

The presence of a new feature sum total in the preferred method, namely: “. . . a signal of the negative feedback is selected and with which by a former, direct current operating conditions is established by placing of an operating point of the amplifying element on a bend of the current sensor dynamic characteristic” determines a correspondence of the preferred engineering embodiment to a criterion “novelty”.

To check the preferred engineering embodiment for a correspondence to a criterion “essential distinctions” a comparison of the distinguish features with ones of known engineering embodiments was made and which showed that a sum total of such features as: “. . . a signal of the negative feedback is selected and with which by a former, direct current operating conditions is established by placing of an operating point of the amplifying element on a bend of the current sensor dynamic characteristic”, in known engineering embodiments is absent that lets to draw a conclusion about a correspondence of the preferred engineering embodiment to a criterion “essential distinctions”.

A correspondence of the preferred engineering embodiment to a criterion “positive effect” is determined so that in the preferred method a new feature sum total, namely: selection of a signal of the negative feedback, with which by a former, direct current operating conditions is established by placing of an operating point of the amplifying element on a bend of the current sensor dynamic characteristic lets to obtain the object of the invention, namely stabilization of operating conditions in electronic schemes independent of a temperature of crystal body of the amplifying element and an environmental temperature that gives a right to draw a conclusion about a correspondence of the preferred engineering embodiment to a criterion “positive effect”.

### BRIEF DESCRIPTION OF DRAWINGS

FIG. 1 is a structural schematic representation of a device according to the preferred method. It is proposed to provide a device, comprising a current sensor 1, a former 2 and an amplifying element 3.

FIG. 2 is a graph of dynamic characteristics of the amplifying element and current sensor.

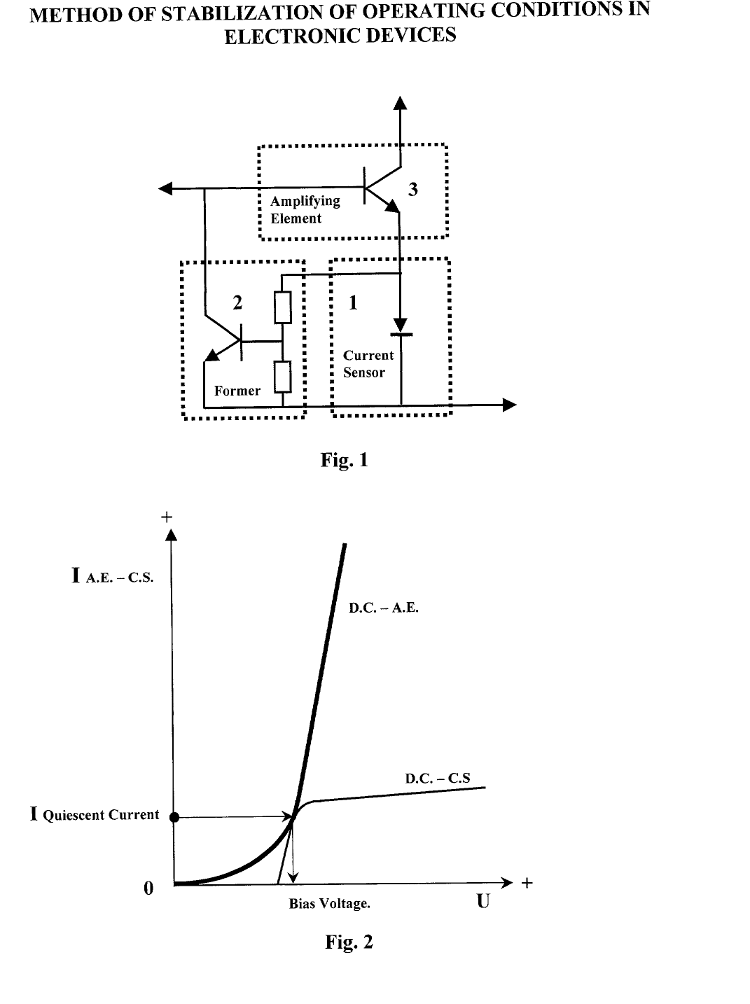

References for FIG. 2:

I A.E.-C.S. through current through amplifying element and current sensor

D.C.-A.E. dynamic characteristic of amplifying element

D.C.-C.S. dynamic characteristic of current sensor

B.V. bias voltage on A.E.(amplifying element)

I quiescent current-operating point of A.E.(amplifying element)

### DESCRIPTION OF THE PREFERRED EMBODIMENT

The preferred method is realized as follows: a signal from a current sensor 1 is selected to input of a former 2 having a resistive divider to regulate sensitivity of a former 2. A signal from output of a former 2 is controlled by bias voltage in input of an amplifying element 3 and with a voltage divider of a former 2 an operating point of an amplifying element 3 is placed on a bend of the dynamic characteristic of a current sensor 1 as shown in FIG. 2.

The preferred method of establishing and stabilization of operating conditions in electronic devices by using of a new feature sum total in it, namely: “. . . a signal of the negative feedback is selected, with which by a former, direct current operating conditions by placing of an operating point of the amplifying element on a bend of the current sensor dynamic characteristic” lets to ensure stabilization of operating conditions in electronic schemes independent of a temperature of crystal body of the amplifying element and an environmental temperature.

What is clamed is:

1. Method of stabilization of operating conditions in electronic devices concluding in that from the current sensor having non-linear voltage-current characteristic which is analogous to PN transition, a signal of the negative feedback is selected with which by a former said operating conditions is established by placing of an operating point of the amplifying element on a bend of the dynamic characteristic of said current sensor.
